(19) United States
(12) Patent Application Publication
(10) Pub. No.: US 2009/0157896 A1
(43) Pub. Date: Jun. 18, 2009

(54) TCP OFFLOAD ENGINE APPARATUS AND METHOD FOR SYSTEM CALL PROCESSING FOR STATIC FILE TRANSMISSION

(75) Inventors: Sun-Wook KIM, DaeJeon (KR); Seong-Woon Kim, DaeJeon (KR); Myung-Joon Kim, DaeJeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/264,719

(22) Filed: Nov. 4, 2008

(30) Foreign Application Priority Data
Dec. 17, 2007 (KR) 10-2007-132580

(51) Int. Cl. G06F 15/16

(52) U.S. Cl. 709/232

(57) ABSTRACT

Provided are a TCP offload engine (TOE) apparatus and method for static file transmission. An apparatus for system call processing for static file transmission includes an application program block for generating a file transmission command upon a user's file transmission request, a BSD socket module for converting the file transmission command of a file unit into a division transmission command for division-transmission of a certain size unit, a TOE kernel module for receiving the division transmission command and converting the division transmission command into a TOE control command, and a TOE apparatus module for generating a data packet of the certain size for network transmission in response to the TOE control command and transmitting the data packet to a node having requested file transmission.

### CROSS-REFERENCE TO RELATED APPLICATIONS

This application claims priority under 35 U.S.C. §119 to Korean Patent Application No. P2007-132580, filed on Dec. 17, 2007, the disclosure of which is incorporated herein by reference in its entirety.

### BACKGROUND OF THE INVENTION

1. Field of the Invention

The present disclosure relates to a transmission control protocol (TCP) offload engine (TOE) apparatus and method for system call processing for static file transmission, and more particularly, to a TOE apparatus and method for system call processing for static file transmission, which are capable of providing a smooth interface with an application program by supporting a system call for file transmission based on TOE, i.e., hardware for network protocol (NP) acceleration at the time of transmission of static file data, thereby improving system performance and reducing system load.

This work was supported by the IT R&D program of MIC/IITA. [2007-S-016-01, A Development of Cost Effective and Large Scale Global Internet Service Solution]

2. Description of the Related Art

As the super-high speed Internet is being widely used, new Internet services are being rapidly developed, as well as existing Internet services. Also, a rapid increase in web-service use is increasing demands for transmission of massive audio and video data over network.

A related art method for static-file transmission over network uses both a read system call and a write system call. In detail, a data buffer is allocated to a user area, file data is copied into the data buffer through a read system call, and the file data stored in the user area is transmitted to a transmission buffer of a network interface through a write system call and then transmitted to a network through a controller.

However, this method needs a process of copying every file data at least twice, which makes an operation very complicated and requires a context-switching process using a central processing unit (CPU) a lot.

Another related art method for file data transmission will now be described. When there is a data transmission request from a client program that has accessed a web server system using a kernel level function of the web server system, the web server system calls a specific user level function to determine whether the size of data requested by the client program is larger than a certain size. If the data size is larger than the certain size, the web server system calls a specific kernel level function to load massive data and copy the data into a kernel buffer, and then transmits the data to the client program through a network interface.

However, this method has poor compatibility with a system in a different environment because a web server and an operating system (OS) must be changed for implementation of a specific command.

As still another related art method for file data transmission, there is a sendfile system call technique in a server application program. In general, a server-client relationship is formed between systems connected over network, and a network program is required for communication between those systems. In the network program, data is transmitted/received through a socket that may be considered as a communication access point written in software. A command supported by an OS for static-file transmission though the socket is called a sendfile system call.

In a zero-copy technique of the sendfile system call, file data is copied into a kernel buffer of an OS through a direct memory access (DMA) engine, and is transmitted to the network through a protocol engine, i.e., a network card.

No file data is copied into a socket buffer, and only a descriptor having location and size information of file data to be transmitted is stored in the socket buffer.

Accordingly, there is no need to copy the file data between kernel buffers by the OS, and thus the number of times that the file data is copied, load of a CPU, damage to a cache, and the number of times of context-switching are reduced. Therefore, the zero-copy technique is a data transmission technique that is capable of improving performance of an application program.

FIG. 1 is a block diagram illustrating a related art process of processing a sendfile system call based on an OS.

Referring to FIG. 1, in operation S110, a user accesses a server node 120 through a client node 110 to make a request for transmission of a static file to be used.

In operation S120, a network server application program 121 of the server node 120 receives the request and requests transmission of the desired static file from an OS kernel 122.

In operation S130, the OS kernel 122 searches for the corresponding static file from a data storage 124 including, e.g., a hard disk, and copies the searched static file into a kernel buffer 123.

In operation S140, the OS kernel 122 transmits the corresponding static file stored in the kernel buffer 123 to the client node 110.

FIG. 2 is a flowchart illustrating a related-art process of calling functions for sendfile system call processing.

In operation S210, the network server application program 121 transmits a sendfile system call to the OS kernel 122 upon a user's request.

In operation S220, the OS kernel 122 calls do_send_file( ) function by referencing the sendfile system call. In operation S230, the do_send_file( ) function calls file_send_actor( ) function of a network system.

The file_send_actor( ) function calls do_tcp_sendpage( ) function, and the do_tcp_sendpage( ) function finally performs file data transmission over network.

The do_tcp_sendpage( ) function performs a transmission command by dividing one static file data in units of a kernel page of 4 k bytes.

The above-described related art method for file data transmission has limitations in that server performance fails to catch up with an increase in network link speed because transmission information and data packets are generated and transmitted at the network layer based on the OS.

### SUMMARY

Therefore, an object of the present invention is to provide a TOE apparatus and method for static file transmission, which are capable of providing a smooth interface with an application program by supporting a system call for file transmission based on TOE, i.e., hardware for network protocol acceleration at the time of transmission of static file data, so that system performance can be improved and system load can be reduced.

To achieve these and other advantages and in accordance with the purpose(s) of the present invention as embodied and broadly described herein, an apparatus for system call processing for static file transmission in accordance with an aspect of the present invention includes: an application program block for generating a file transmission command upon a user's file transmission request; a BSD socket module for converting the file transmission command of a file unit into a division-transmission command for division-transmission of a certain size unit; a transmission control protocol (TCP) offload engine (TOE) kernel module for receiving the division transmission command and converting the received division transmission command into a TOE control command; and a TOE apparatus module for generating a data packet of the certain size for network transmission in response to the TOE control command and transmitting the data packet to a node requesting file transmission.

To achieve these and other advantages and in accordance with the purpose(s) of the present invention, a transmission control protocol (TCP) offload engine (TOE) apparatus for static file transmission in accordance with another aspect of the present invention includes: a socket resource control and TCP command pool for storing a socket resource control command and a TCP connection/disconnection command; a message transmission/reception command pool for storing a message transmission/reception command based on the network protocol; a reception packet information pool for storing information of a packet whose transmission has been completed; a command processing completion information pool for storing results of processing the socket resource control command, the TCP connection/disconnection command and the message transmission/reception command; and a TOE-embedded processor for processing the socket resource control command, the TCP connection/disconnection command and the transmission/reception command and processing packet transmission/reception.

To achieve these and other advantages and in accordance with the purpose(s) of the present invention, a method for system call processing for static file transmission in a transmission control protocol (TCP) offload engine (TOE)-based system in accordance with another aspect of the present invention includes: receiving a division transmission command for division-transmission of a static file in units of a page of a certain size, and buffering the division transmission command to a command pool; determining whether the received division transmission command is the last division transmission command associated with the static file transmission; and receiving the next division transmission command.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram illustrating a related art process of processing a sendfile system call based on an OS;

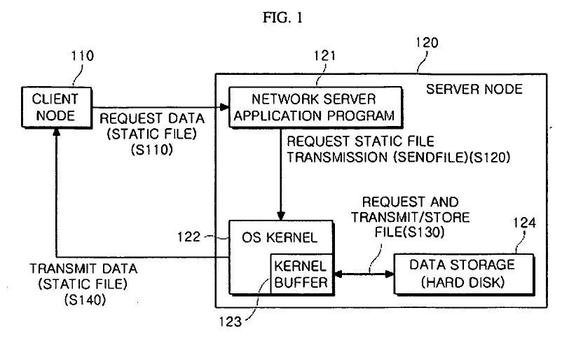

FIG. 2 is a flowchart illustrating a related art process of calling functions for sendfile system call processing;

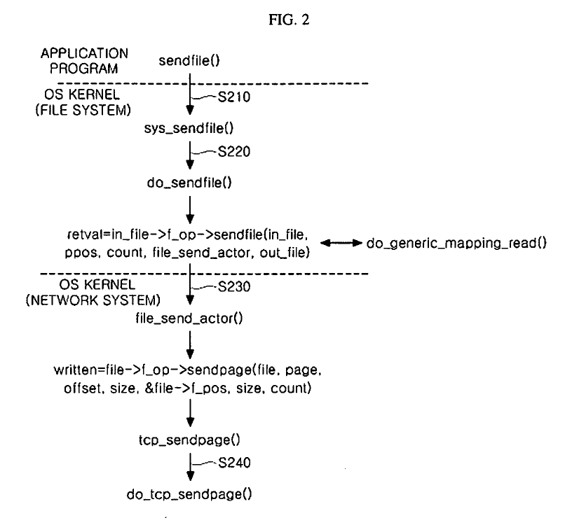

FIG. 3 is a block diagram illustrating a TOE apparatus for static file transmission according to an embodiment of the present invention;

FIGS. 4A and 4B are block diagrams respectively illustrating an apparatus for system call processing for static file transmission according to an embodiment of the present invention, and a related art apparatus for system call processing for static file transmission;

FIG. 5 illustrates a format of a sendpage transmission command that is changed to a command based on TOE apparatus module according to an embodiment of the present invention; and

FIG. 6 is a flowchart illustrating a method for system call processing for static file transmission according to an embodiment of the present invention.

### DETAILED DESCRIPTION OF EMBODIMENTS

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

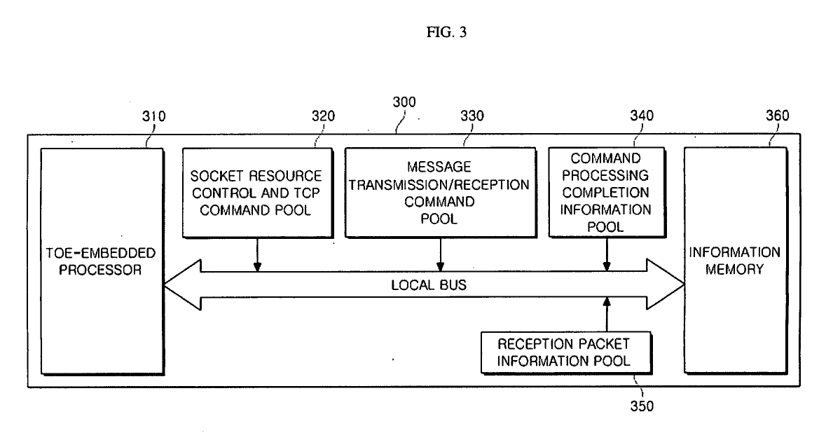

FIG. 3 is a block diagram illustrating a TOE apparatus for static file transmission according to an embodiment of the present invention. As shown in FIG. 3, the TOE apparatus for static file transmission includes a socket-resource control and TCP command pool 320 for storing a socket-resource control command, and a TCP connection/disconnection command; a message-transmission/reception command pool 330 for storing a network protocol-based message transmission/reception command; a reception-packet information pool 350 for storing information of a packet whose transmission has been completed; a command-processing completion information pool 340 for storing results of processing the socket-resource control command, the TCP connection/disconnection command and the message transmission/reception command; and a TOE-embedded processor 310 for processing the socket-resource control command, the TCP connection/disconnection command and the message transmission/reception command, and processing packet transmission/reception.

The socket-resource control and TCP command pool 320 stores a TCP connection/disconnection command and a socket resource control command associated with, e.g., socket generation and deletion and attribute changes.

The message transmission/reception command pool 330 stores an NP-based message transmission/reception command requested by a network application program with respect to a generated socket.

The transmission/reception command stored by the message transmission/reception command pool 330 is a sendpage command being a packet transmission command upon a user's request.

The reception-packet information pool 350 stores information of a packet that is generated as the TOE-embedded processor 310 processes a packet received from the outside.

The command processing completion information pool 340 stores information of a result of processing each data transmission/reception command.

The TOE-embedded processor 310 processes a TOE for network acceleration and a network transmission/reception protocol constituting the TOE, i.e., a socket-resource control command, a TCP connection/disconnection command, a transmission/reception command, and packet transmission/reception.

Besides, the TOE apparatus for static file transmission further includes an information memory 360 for storing packet transmission information and socket resource information under the control of the TOE-embedded processor 310.

The TOE apparatus for static file transmission according to an embodiment of the present invention includes a processor and is controlled by firmware, so that data transmission processing can be accelerated.

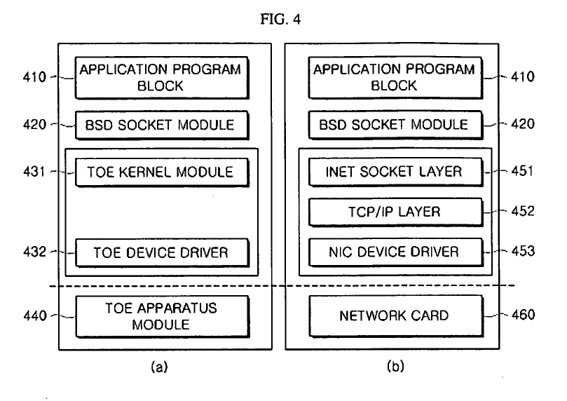

FIG. 4A is a block diagram illustrating an apparatus for system call processing for static file transmission according to an embodiment of the present invention, and FIG. 4B is a block diagram illustrating a related art apparatus for system call processing for static file transmission for comparison with the present invention.

As shown in FIG. 4A, the apparatus for system call processing for static file transmission includes an application program block 410 for generating a sendfile command upon a user's request for file transmission; a BSD socket module 420 for converting the sendfile command into a sendpage command being a division-transmission command for division-transmission of a specific file in units of a certain-size; a TOE kernel module 431 for receiving the sendpage command and converting the sendpage command into a TOE control command; and a TOE apparatus module 440 for generating a data packet of a certain size unit for network transmission in response to the TOE control command and transmitting the data packet to a node having requested the file transmission.

The application program block 410 provides an application program for a user input/output (I/O) interface. A client user accesses a server, inputs a data transmission request using a sendfile system call through an application program of the server, and confirms a result of processing the data transmission request.

The BSD socket module 420 converts the sendfile system call, which is a file transmission command transmitted by the application program block 410, into a sendpage command being a division-transmission command for division-transmission of a specific file in units of a certain size.

The sendpage command is a command for transmission in units of a certain size (page unit), in general, in units of a kernel page of 4 k bytes.

In detail, the sendpage command includes information of a transmission protocol, a transmission command type, a command order identifier, the number of transmission data, a socket identifier, a physical address and size of transmission data, a transmission destination, and a transmission port. Also, the sendpage command is a command that is reconfigured based on the TOE by the TOE kernel module 431.

For example, if a sendfile system call for file data is larger than 4 k bytes, a process of dividing the sendfile system call into a plurality of sendpage commands is repetitively performed.

Since the TOE apparatus module 440 performs a transmission command in units of 4 k bytes at the time of packet transmission of file data, transmission of the file data may be performed in units of 4 k bytes for efficient use of the TOE apparatus module 440 and the network.

The TOE kernel module 431 substitutes a related art INET socket layer 451 of FIG. 4B. The TOE kernel module 431 converts the sendpage command into a TOE control command and transmits the TOE control command to a TOE device driver 432, and the TOE device driver 432 controls the TOE apparatus module 440 in response to the corresponding command.

That is, the TOE device driver 432 for controlling the TOE apparatus module 440 in response to the TOE control command is further included between the TOE kernel module 431 and the TOE apparatus module 440.

The TOE apparatus module 440 exists at the physical layer where a related art network 460 of FIG. 4B is placed, and performs a function of the TCP/IP layer 452 of FIG. 4B by hardware.

That is, the TOE apparatus module 440 generates a data packet for network transmission in response to the TOE control command on the internal hardware basis, and transmits the data packet to another client user.

The TOE apparatus module 440 generates the data packet for network transmission based on TCP/IP protocol.

The TOE apparatus module 440 includes a buffer (not shown), and stores in the buffer (not shown), a TOE control command received from the TOE kernel module 431 and to be processed, and a transmission confirmation message to be transmitted to the TOE kernel module 431.

The TOE kernel module 431 may employs a method of transmitting the sendpage command to the TOE apparatus module 440, sleeping a corresponding process until it receives information, which indicates completion of processing of the corresponding transmission command, from the TOE apparatus module 440 through the command processing completion information pool 340, and waking up the process after the corresponding information is received to transmit next commands. However, because repetitive sleeping/waking-up is performed for each sendpage command, efficient use of resources and network becomes difficult.

Therefore, the TOE apparatus module 440 employs a method in which after receiving the sendpage command for file data to be transmitted, the TOE apparatus module 440 transmits information indicating completion of command processing to the TOE kernel module 431 regardless of transmission of a corresponding file data packet, and then receives a next sendpage command, so that a plurality of file data packets can be transmitted more efficiently through buffering of the sendpage command.

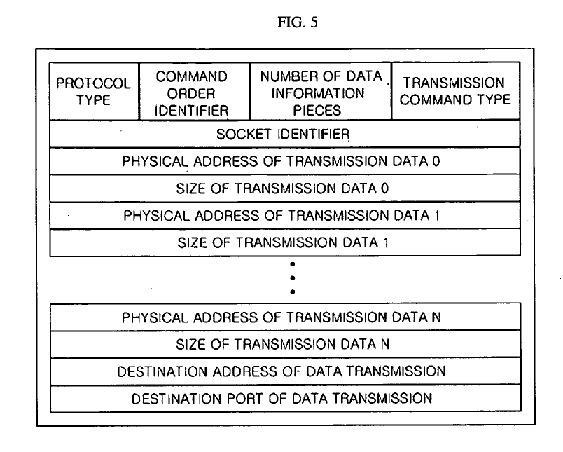

FIG. 5 illustrates a format of a sendpage transmission command changed to a command based on the TOE apparatus module and stored in the message transmission/reception command pool 330. As shown in FIG. 5, the sendpage transmission command includes information of a protocol type, a command order identifier, the number of data information pieces, a transmission command type, a socket identifier, a physical address of transmission data, a size of the transmission data, a destination address of data transmission, and a destination port of the data transmission.

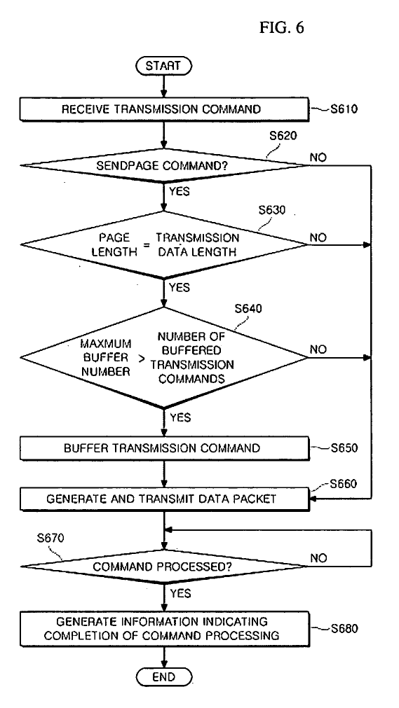

FIG. 6 is a flowchart illustrating a method of system call processing for static file transmission according to an embodiment of the present invention.

Referring to FIG. 6, in operation S610, the TOE kernel module 431 receives a file transmission command transmitted through a network application program upon a user's request.

Before the operation S610, the TOE kernel module 431 generates a sendfile command upon a file transmission request, and converts the sendfile command of a file unit into a sendpage command of a certain size unit.

In operation S620, the TOE kernel module 431 determines whether the received command is a sendpage command. In operation S630, if the received command is a sendpage command, the TOE kernel module 431 compares the size of page with a size of transmission data to be transmitted, thereby determining whether the received sendpage command is the last sendpage command of the corresponding sendfile command.

In detail, protocol firmware of the TOE-embedded processor 310 confirms that the corresponding command is a sendpage command through a transmission command type field of the sendpage command.

Then, it is determined whether the size of the transmission data to be transmitted by the sendpage command is identical to the page size, e.g., 4 k bytes in operation S630. If the transmission data size of the sendpage command is identical to the page size, it is determined that the corresponding sendpage command is not the last sendpage command. If not, it is determined that the corresponding sendpage command is the last sendpage command.

In operation S640, if the sendpage command is not the last sendpage command, it is determined whether the number of transmission commands being buffered is smaller than a maximum buffer number in order to determine whether buffering is possible.

In operation S650, if the number of transmission commands being buffered is smaller than the maximum buffer number of the transmission/reception command pool 330, the TOE apparatus module 440 transmits information indicating completion of command processing to the TOE kernel module 431 regardless of transmission of data packets to immediately receive a next sendpage command from the TOE kernel module 431, and thus receives and buffers the next sendpage command.

In operation S660, the TOE apparatus module 440 generates a data packet and transmits the data packet to another node.

After transmitting the data packet, the TOE apparatus module 440 receives a signal indicating completion of reception from another node, then generates information indicating completion of command processing with respect to the sendfile command, and transmits the information to the TOE kernel module 431.

Thus, the TOE apparatus according to the embodiment of the present invention causes sleep/wakeup in units of a sendfile command or a message transmission/reception command pool 330, not in units of a sendpage command, so that resource and network efficiency can be improved.

In more detail, the TOE apparatus module 440 generates transmission information, which includes, e.g., a physical address and a size, from the sendpage command, and stores the transmission information in the information memory 360. The TOE apparatus module 440 generates a data packet to be transmitted by referencing the transmission information, and transmits the data packet.

The transmission information includes a physical address and size dividing data to be transmitted into network packet size units.

Thereafter, stored file data are transmitted to the client node 110 requesting the file data through the TOE apparatus module 440.

In operation S670, the TOE apparatus module 440 receives a confirmation message associated with transmission of the data packet from the client node 110, thereby recognizing that the command has been processed. In operation S680, the TOE apparatus module 440 generates information indicating completion of command processing to inform the TOE kernel module 431 that the data packet has been transmitted.

If the transmission command is transmitted in units of 4 k bytes, the TOE apparatus module 440 may transmit information indicating completion of command processing to the TOE kernel module after completing transmission of the corresponding data packet and receiving a message indicating completion of reception of the file data packet from the client node 110.

The TOE apparatus module 440 may employ a method in which after receiving a sendpage command of a unit of 4 k bytes for file data to be transmitted, the TOE apparatus module 440 transmits information indicating completion of command processing regardless of transmission of packets of the corresponding file data to the TOE kernel module 431, and then receives a next command. In this case, a plurality of packets of the file data can be transmitted through buffering of the sendpage commands, so that TOE hardware resource and network can be more efficiently used.

If the received transmission command is not the sendpage command in operation S620, if the size of the transmission data is different from the page size in operation S630, or if the number of transmission commands being buffered exceeds the maximum buffer number in operation S640, transmission information is generated without performing buffering to transmit data packets in operations S660 and S670. Then, information indicating completion of command processing is generated and is provided to the user in operation S680.

The TOE apparatus and method for static file transmission according to the present invention can provide a smooth interface with an application program by implementing a TOE as firmware and supporting a system call for file transmission at the time of transmission of static file data. Accordingly, system performance can be improved and system load can be reduced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. An apparatus for system call processing for static file transmission, the apparatus comprising:
an application program block for generating a file transmission command upon a user's file transmission request;
a BSD socket module for converting the file transmission command of a file unit into a division-transmission command for division-transmission of a certain size unit;
a transmission control protocol (TCP) offload engine (TOE) kernel module for receiving the division transmission command and converting the received division transmission command into a TOE control command; and
a TOE apparatus module for generating a data packet of the certain size for network transmission in response to the TOE control command and transmitting the data packet to a node requesting file transmission.

2. The apparatus of claim 1, wherein the TOE apparatus module informs a user of information indicating completion of command processing associated with the file transmission through the TOE kernel module, the BSD socket module and the application program block.

3. The apparatus of claim 1, wherein the division transmission command of the certain size unit comprises information of a transmission command type, a physical address of transmission data, a size of the transmission data, a socket identifier, a transmission destination and a transmission port, and is a command that is reconfigured based on the TOE apparatus module.

4. The apparatus of claim 3, wherein the certain size unit is a page unit of 4 k bytes.

5. The apparatus of claim 1, wherein the TOE apparatus module comprises a buffer for storing a TOE control command received from the TOE kernel module and to be processed, and a transmission confirmation message to be transmitted to the TOE kernel module.

6. The apparatus of claim 1, further comprising a TOE device driver for receiving the TOE control command and controlling the TOE apparatus module.

7. A transmission control protocol (TCP) offload engine (TOE) apparatus for static file transmission, the TOE apparatus comprising:
a socket resource control and TCP command pool for storing a socket resource control command and a TCP connection and disconnection command;
a message transmission and reception command pool for storing a message transmission and reception command based on the network protocol;
a reception packet information pool for storing information of a packet whose transmission has been completed;
a command processing completion information pool for storing results of processing the socket resource control command, the TCP connection and disconnection command and the message transmission and reception command; and
a TOE-embedded processor for processing the socket resource control command, the TCP connection and disconnection command and the transmission and reception command, and processing packet transmission/reception.

8. The TOE apparatus of claim 7, wherein the message transmission and reception command pool stores a packet transmission command upon a user's request.

9. The TOE apparatus of claim 7, further comprising an information memory for storing packet transmission information and socket resource information under the control of the TOE-embedded processor.

10. A method for system call processing for static file transmission in a transmission control protocol (TCP) offload engine (TOE)-based system, the method comprising:
receiving a division transmission command for division-transmission of a static file in units of a page of a certain size, and buffering the division transmission command to a command pool;
determining whether the received division transmission command is the last division transmission command associated with the static file transmission;
generating information indicating completion of command processing in response to the division transmission command regardless of actual data transmission, and transmitting the generated information to an upper layer module, if the received division transmission command is not the last division transmission command and a next division transmission command is to be buffered into the command pool; and
receiving the next division transmission command.

11. The method of claim 10, wherein the determining of the last division transmission comprises:
comparing a size of transmission data that is to be transmitted by the division transmission command with a size of the page; and
determining that the received division transmission command is the last division transmission command associated with the corresponding file if the size of the transmission data that is t be transmitted is not identical to the size of the page.

12. The method of claim 10, further comprising:
transmitting a data packet associated with the file to an external part if the received division transmission command is the last division transmission command associated with the file transmission, or if the next division transmission command is not to be buffered in the command pool; and
generating information indicating completion of command processing according the transmission of the data packet, and transmitting the information to the upper layer module.

13. The method of claim 10, further comprising, before the buffering of the division transmission command:
generating a file transmission command upon a user's file transmission request; and
converting the file transmission command into a plurality of division transmission commands.

14. The method of claim 10, wherein the division transmission command comprises information of a transmission command type, a physical address of transmission data, a size of the transmission data, a socket identifier, a transmission destination, and a transmission port.

15. The method of claim 12, wherein the transmitting of the data packet comprises:
generating transmission information from the division transmission command; and
generating a data packet to be transmitted by referencing the transmission information, and transmitting the data packet.

16. The method of claim 15, wherein the transmission information comprises a physical address and a size dividing data to be transmitted in units of a network packet size.
